(19) United States
(12) Patent Application Publication
(10) Pub. No.: US 2025/0153660 A1
(43) Pub. Date: May 15, 2025

(54) SHIELD STRUCTURE AND SHIELD SHELL PRODUCTION METHOD

(71) Applicant: Yazaki Corporation, Tokyo (JP)

(72) Inventors: Satoki MASUDA, Shizuoka (JP); Ryokei MASUDA, Shizuoka (JP)

(73) Assignee: Yazaki Corporation, Tokyo (JP)

(21) Appl. No.: 18/906,256

(22) Filed: Oct. 4, 2024

(30) Foreign Application Priority Data
Nov. 9, 2023 (JP) 2023-191596

(51) Int. Cl. B60R 16/02; B60R 16/023

(52) U.S. Cl. CPC B60R 16/0215; B60R 16/023

(57) ABSTRACT

A shield structure includes: a shield shell including at least one wall and defining a shielded space, and a vehicle body fastened portion which is continuous with the one wall via a step and configured to be fastened to a target portion, wherein the target portion includes an overlapped surface and a pair of inner surfaces, the overlapped surface being configured to be overlapped with the vehicle body fastened portion, wherein the inner surfaces extends upright from the overlapped surface and opposed to each other, wherein the vehicle body fastened portion includes a pair of contact surfaces on end faces of a plate-shape fastened portion body and is able to come into contact with the inner surfaces, and wherein the contact surfaces is configured to be in contact with the inner surfaces in an overlapped state of the fastened portion body which is overlapped with the overlapped surface.

### BACKGROUND OF THE INVENTION

### Technical Field

The present invention relates to a shield structure and a shield shell production method.

### Background Art

Automobiles are equipped with a wide variety of electronic devices, and wire harnesses are arranged to transfer e.g. power and control signals to the electronic devices. A wire harness is equipped with multiple electric wires and connectors. The wire harness is connected to the electronic devices and other wire harnesses by fitting the connectors into connectors of the electronic devices and other wire harnesses.

Such a wire harness may include a shield structure configured to be fixed to a metallic target portion of a vehicle body to form a shield circuit, wherein the target portion is intended for mounting the shield structure thereto (see e.g. Patent Document 1). One example of a shield structure is a shield structure which includes a shield shell configured to be supported at a predetermined location of an electric wire, wherein the shield shell includes a shielded space. FIG. 9 shows a perspective view of an exemplary conventional shield structure 101.

As shown in FIG. 9, the shield shell 102 includes a tubular shell body 121 defining the shielded space, a plate-shaped vehicle body fixed portion 122 that is continuous with the shell body 121 and configured to be overlapped with and fixed to the vehicle body, and a protruding portion 123 provided at a tip of the vehicle body fixed portion 122 facing from the shell body 121, wherein the protruding portion 123 is bent so as to be engaged with a step portion 111 at a target portion 110 of the vehicle body, wherein the target portion 110 is intended for mounting the shield structure 101 thereto.

For fixing such a conventional shield structure 101 to the target portion 110, the protruding portion 123 of the shield shell 102 is engaged with the step portion 111 of the target portion 110 when the shield shell 102 is fastened to the target portion by means of a bolt, which restricts rotation of the shield shell 102 so that the shield shell 102 is fixed to an appropriate position in a direction of the rotation.

### CITATION LIST

### Patent Literature

Patent Document 1: JP 2017-092418 A

### SUMMARY OF THE INVENTION

However, the protruding portion 123 of the shield shell 102 in the conventional shield structure 101 has a low strength in the direction of rotation around the bolt, which may result in deformation of the protruding portion 123 when a force in the direction of rotation acts thereon. This may cause displacement of the shield shell 102 in the direction of rotation, whereby it may be difficult to fix the shield shell 102 in an appropriate position.

An object of the present invention is to provide a shield structure and a shield shell production method which may allow rotation of the shield shell to be restricted while improving an accuracy of a fixing position on a target portion of a vehicle body.

In order to achieve this object, the present invention relates to a shield structure configured to be fixed to a target portion of a vehicle body, wherein the target portion is intended for mounting the shield structure thereto, the shield structure including: a shield shell including: a shell body having a tubular shape, the shell body including at least one wall and defining a shielded space; and a vehicle body fastened portion which has a plate shape and is continuous with the one wall via a step, the vehicle body fastened portion extending in an axial direction of the shell body and being configured to be fastened to the target portion by means of a bolt, wherein the target portion includes an overlapped surface and a pair of inner surfaces, the overlapped surface being configured to be placed facing the vehicle body fastened portion and overlapped with the vehicle body fastened portion, wherein the pair of inner surfaces extends upright from the overlapped surface and opposed to each other, wherein the vehicle body fastened portion includes a fastened portion body having a plate shape, a bolt hole and a pair of contact surfaces, the bolt hole being provided in the fastened portion body and configured for inserting the bolt therethrough, wherein the pair of contact surfaces is provided on end faces of the fastened portion body in an orthogonal direction and is able to come into contact with the inner surfaces, wherein the orthogonal direction extends orthogonally to an axis of the shell body, and wherein the pair of contact surfaces is configured to be in contact with the pair of inner surfaces in an overlapped state of the fastened portion body which is overlapped with the overlapped surface. The present invention further relates to a shield shell production method of producing a shield shell, including: a deep drawing step of forming a deep-drawn material by applying a cylindrical deep drawing process to a metal sheet, the deep-drawn material including a tubular portion; and a collar-shaped portion producing step of applying a punching process to the deep-drawn material and thus forming a collar-shaped portion which extends continuously in a collar shape along a periphery of the tubular portion; and a step producing step of forming a step by bending the collar-shaped portion at a location thereof which is spaced from the tubular portion.

The present invention may allow rotation of the shield shell to be restricted while improving an accuracy of a fixing position on a target portion of a vehicle body.

### BRIEF DESCRIPTION OF THE DRAWINGS

FIG. 1 shows a perspective view of a shield structure according to an embodiment of the present invention;

FIG. 2 shows a perspective view of a shield shell forming part of the shield structure;

FIG. 3A shows a front view of the shield shell;

FIG. 3B shows a cross-sectional view along the line I-I in FIG. 3A;

FIG. 4 shows a view for explanation of a deep drawing step of a production method of producing the shield shell, in which a molded material produced by means of the deep drawing step (deep-drawn material) is viewed in a direction of drawing;

FIG. 5 shows a vehicle body fastened portion producing step of the production method of producing the shield shell, wherein a molded material produced by means of the vehicle body fastened portion producing step is shown in a view in a radial direction orthogonal to the direction of drawing in (A) and in a view in the direction of drawing in (B);

FIG. 6 shows a molded material produced by means of a step producing step in a radial direction orthogonal to the direction of drawing, wherein the step producing step is included in the production method of producing the shield shell;

FIG. 7 shows an exploded perspective view of the shield structure, wherein this figure serves for illustrating how the shield shell is fastened to a target portion of a vehicle body by means of a bolt;

FIG. 8 shows a top view of a post-process following FIG. 7, wherein the shield structure is viewed from above; and

FIG. 9 shows a perspective view of an exemplary conventional shield structure.

### DETAILED DESCRIPTION OF THE PREFERRED EMBODIMENTS

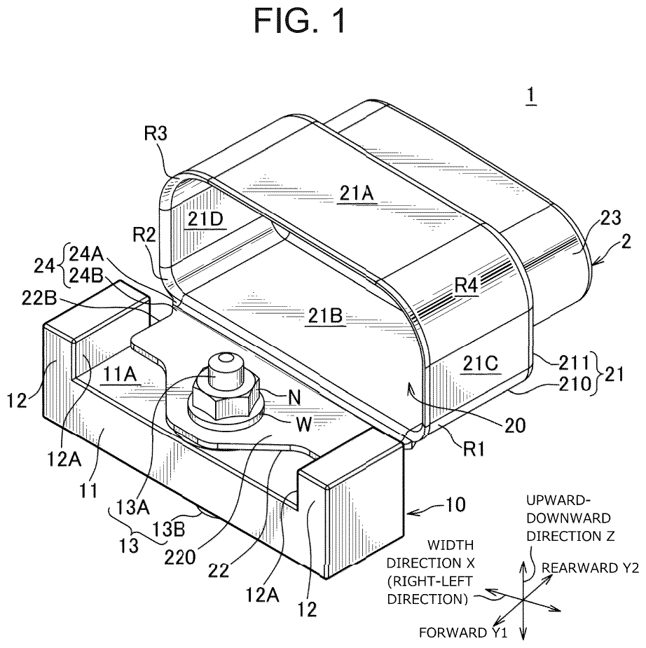

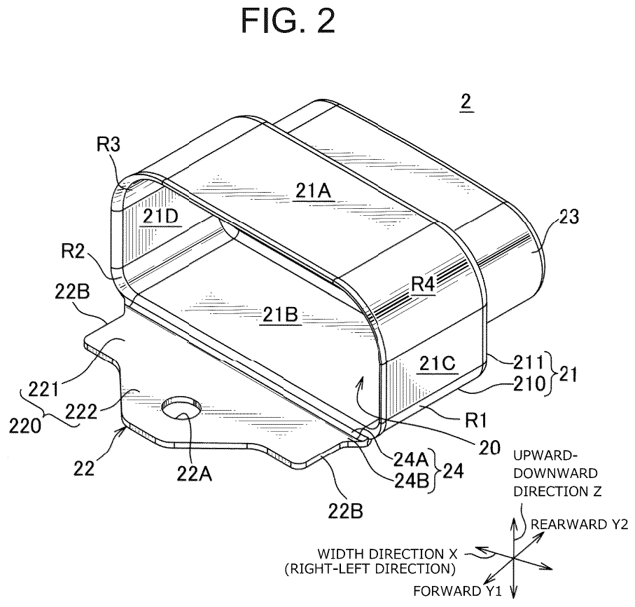

Hereinafter, an embodiment of the present invention will be described with reference to the Drawings FIG. 1 shows a perspective view of a shield structure 1 according to an embodiment of the present invention. FIG. 2 shows a perspective view of a shield shell 2 forming part of the shield structure 1. The shield structure 1 as shown e.g. in FIG. 1 forms part of a wire harness intended to be arranged e.g. in an automobile, wherein the shield structure 1 constitutes a shield circuit for shielding electric noises leaked to the outside of electric wires or entering the electric wires from the outside, the electric wires being configured to transfer e.g. control signals.

As shown in FIG. 1, the shield structure 1 according to the present embodiment includes a tubular-shaped shield shell 2 and a housing (not shown), wherein the shield shell 2 is configured to be supported in predetermined positions of an electric wire (not shown) and to be fixed to a metallic target portion 10 of a vehicle body for forming a shield circuit, and has a shielded space 20 as shown in FIGS. 1 and 2, the target portion 10 being intended for mounting the shield structure 1 thereto, wherein the housing is configured to hold the electric wire and to be inserted into the shielded space 20.

Hereinafter, an axial direction of the shield shell 2 may be referred to as a “forward-rearward direction” and indicated by an arrow Y. A direction orthogonal to the arrow Y in which a pair of inner surfaces 12A, 12A of the target portion 10 (which will be described below) is opposed to each other may be referred to as a “right-left direction” or “width direction” and indicated by an arrow X. A direction orthogonal to the arrows X and Y may be referred to as a “upward-downward direction” and indicated by an arrow Z.

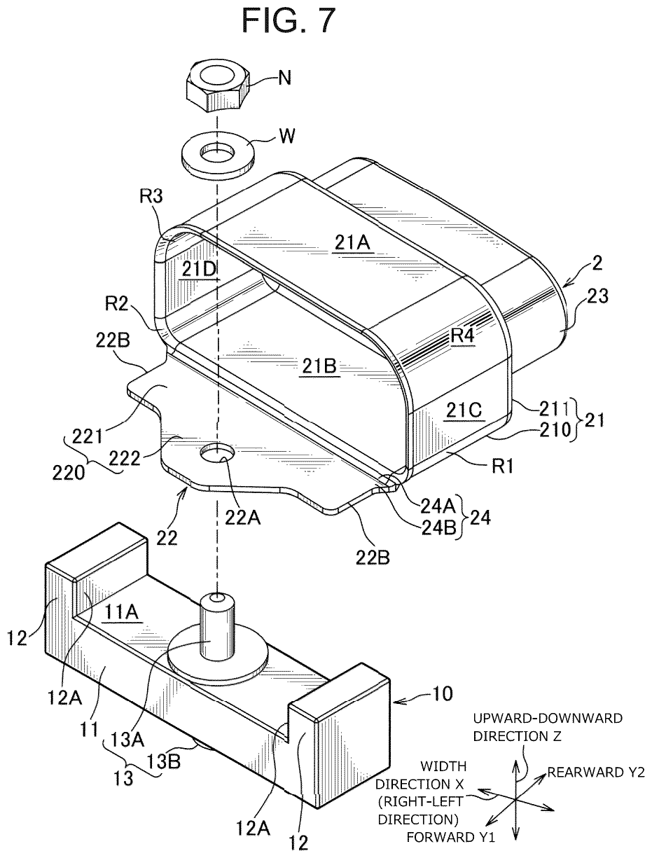

As shown in FIGS. 1 and 7, the target portion 10 includes a first wall 11 and a pair of second walls 12, 12, the first wall 11 including an overlapped surface 11A configured to be placed facing a vehicle body fastened portion 22 of the shield shell 2 as described below and to be overlapped with the vehicle body fastened portion 22, wherein the pair of second walls 12, 12 extends upright from the first wall 11 and includes surfaces (inner surfaces) 12A opposed to each other. According to the present embodiment, the overlapped surface 11A is formed by a planar surface in which the forward-rearward direction Y and the right-left direction X extend. Furthermore, the inner surface 12A of each of the pair of second walls 12, 12 is formed by a planar surface in which the upward-downward direction Z and the forward-rearward direction Y extend. As shown in FIG. 7, a bolt shaft 13A of a bolt 13 is provided in the target portion 10 to extend through the first wall 11 and extend upright from the overlapped surface 11A. The bolt 13 includes the bolt shaft 13A and a bolt head 13B, wherein the bolt head 13B is provided at an end of the bolt shaft 13A.

The shield shell 2 is formed by pressing a conductive metal sheet. As shown in FIG. 2, the shield shell 2 includes a shell body 21, a tubular portion 22, a plate-shaped vehicle body fastened portion 23, a cylindrical portion 23 and an intermediate portion 24, the shell body 21 having a tubular shape and defining the shielded space 20, wherein the vehicle body fastened portion 23 is provided at the shell body 21 on its one side (forward side Y1) and is configured to be fastened to a target portion 10 by means of a bolt, wherein the target portion is intended for mounting the shield structure thereto, wherein the cylindrical portion 23 is continuous with the shell body 21 on its opposite side (rearward side Y2), and wherein the intermediate portion 24 includes a step 24A which is provided between a bottom wall 21B of the shell body 21 and the vehicle body fastened portion 22 and continuous with the bottom wall 21B and the vehicle body fastened portion 22.

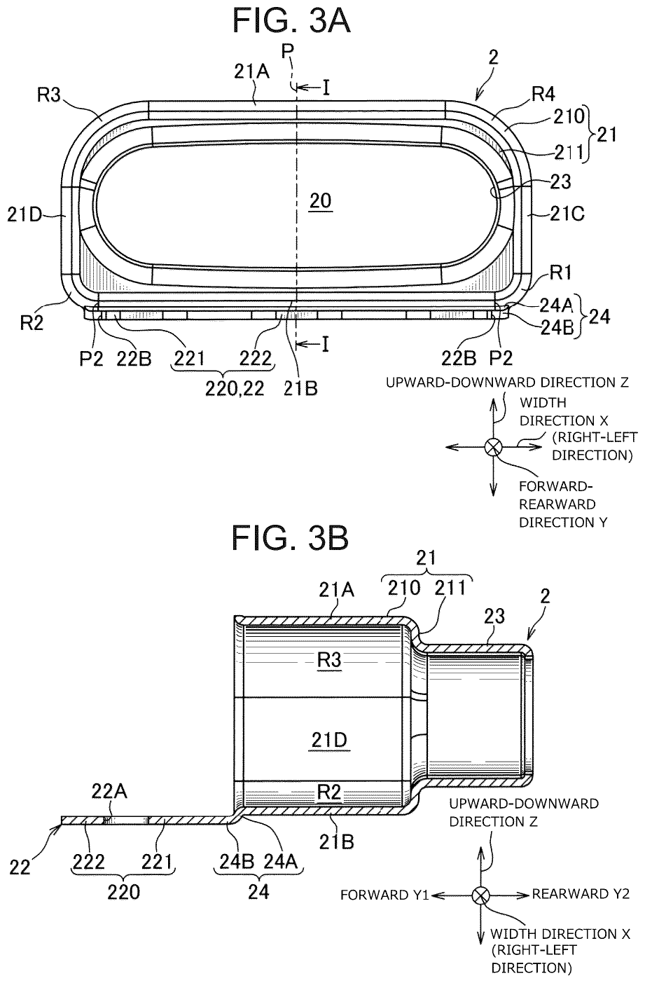

Furthermore, the shield shell 2 is symmetrical on the right and left sides with respect to an imaginary line P as an axis of symmetry as shown in FIGS. 3A and 3B, wherein the imaginary line P extends in the forward-rearward direction Y.

As shown in FIGS. 3A and 3B, the shell body 21 includes an accommodation body 210 and a closure wall 211, the accommodation body 210 being formed in a quadrilateral tubular shape with an axis extending along the forward-rearward direction Y to define the shielded space 20, wherein the closure wall 211 is placed at a rearward end of the accommodation body 210 and fills a gap between the accommodation body 210 and the cylindrical portion 23.

The accommodation body 210 includes an upper wall 21A, the bottom wall 21B (one wall) and a pair of side walls 21C and 21D. The accommodation body 210 further includes four bent portions R1, R2, R3 and R4 between the four walls 21A, 21B, 21C and 21D, wherein the bent portions R1, R2, R3 and R4 are continuous with the four walls 21A, 21B, 21C and 21D and form corners of the accommodation body 210. As shown in FIG. 3A, bent portions R1 and R2 of the four bent portions R1, R2, R3 and R4 are continuous with the bottom wall 21B on its opposite sides in the right-left direction X.

The vehicle body fastened portion 22 is formed in a plate shape which extends in the forward-rearward direction Y and the right-left direction X as shown in FIG. 2, wherein the vehicle body fastened portion 22 is continuous with the bottom wall 21B of the shell body 21 via the intermediate portion 24 including the step 24A. This means that the step 24A which is part of the intermediate portion 24 is provided between the vehicle body fastened portion 22 and the bottom wall 21B of the shell body 21.

The vehicle body fastened portion 22 includes a fastened portion body 220 having a planar plate shape, a bolt hole 22A and a pair of contact surfaces 22B, 22B, the bolt hole 22A being provided in the fastened portion body 220 and configured for inserting the bolt shaft 13A therethrough, wherein the pair of contact surfaces 22B, 22B is provided in the fastened portion body 220 and is able to come into contact with the pair of inner surfaces 12A, 12A of the target portion 10.

The fastened portion body 220 includes a rectangular portion 221 and a triangle portion 222, the rectangular portion 221 being continuous with the intermediate portion 24 on the forward side Y1, wherein the triangle portion 222 is continuous with the rectangular portion 221 on the forward side Y1.

The rectangular portion 221 has a constant width dimension and continuous on the forward side Y1 so that the imaginary line P extends through a central portion of the rectangular portion 221 in the right-left direction X.

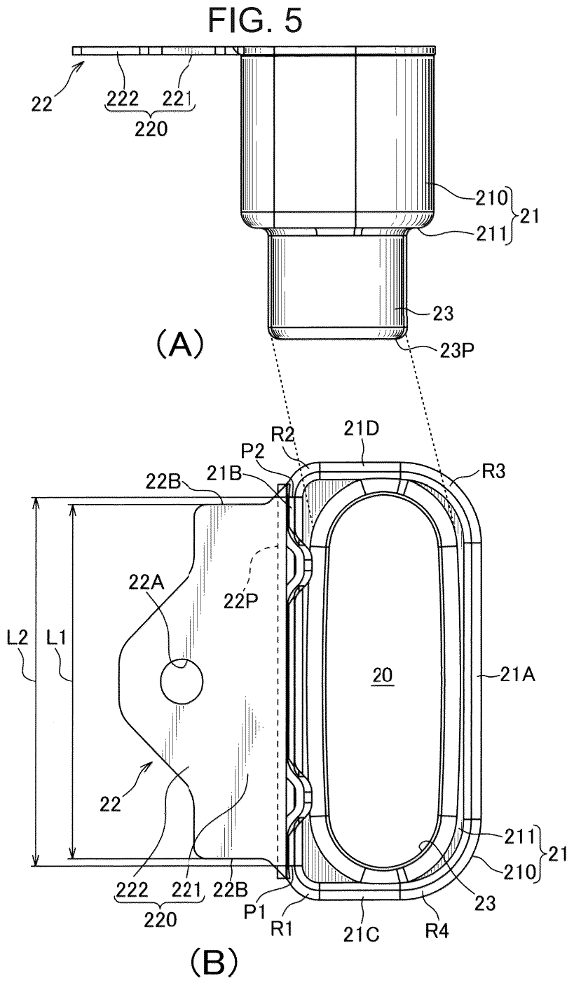

As shown in (B) in FIG. 5, the rectangular portion 221 has a width dimension L1 which is smaller than a width dimension L2 of the bottom wall 21B of the shell body 21. In other words, opposite end edges of the rectangular portion 221 in the right-left direction X (positions of the rectangular portion 221 in which the pair of contact surfaces 22B, 22B are formed) are arranged within opposite ends P1 and P2 of the bottom wall 21B of the shell body 21 in the right-left direction X (boundary positions between the bottom wall 21B and respective bent portions R1 and R2). Furthermore, the rectangular portion 221 is configured such that the width dimension L1 of the rectangular portion 221 (dimension between the pair of contact surfaces 22B, 22B) is substantially equal to a dimension between the pair of inner surfaces 12A, 12A of the target portion 10.

The triangle portion 222 is configured in a triangular shape so that the imaginary line P extends through a central portion of the triangle portion 222 in the right-left direction X, wherein the triangular shape has a width dimension which is gradually reduced toward the forward side Y1.

The pair of contact surfaces 22B, 22B is formed by end faces on opposite sides of the rectangular portion 221 in the right-left direction X and includes surfaces which include the forward-rearward direction Y and upward-downward direction Z.

The bolt hole 22A is formed in the triangle portion 222, wherein the bolt hole 22A has a center which is positioned in a position overlapped with the imaginary line P.

The intermediate portion 24 includes the step 24A and an extending portion 24B, wherein the step 24A is continuous with the bottom wall 21B of the shell body 21 and is bent to extend downward, wherein the extending portion 24B is provided between a lower end of the step 24A and the rectangular portion 221 of the fastened portion body 220.

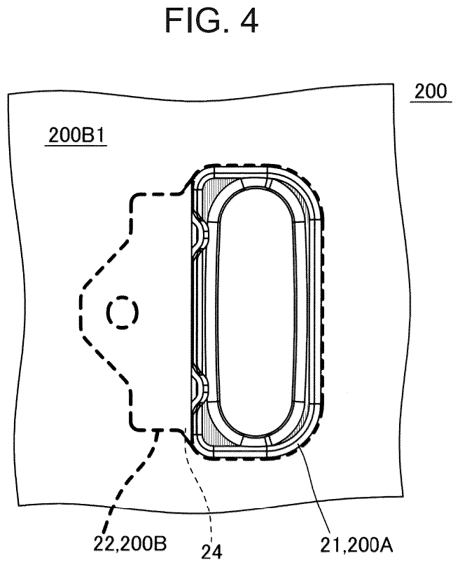

In the following, a production procedure for producing the above-described shield shell 2 (shield shell production method) will be described with reference to FIGS. 4 to 6.

First, a cylindrical deep drawing process is applied to one metal sheet to form a deep-drawn material 200 with a tubular portion 200A (including a shell body 21 and a cylindrical portion 23) as shown in FIG. 4 (deep drawing step).

Subsequently, a punching process is applied to the deep-drawn material 200 to form a collar-shaped portion 200B which extends continuously in a collar shape along a periphery of the tubular portion 200A, wherein an unused portion 200B1 is cut off simultaneously (collar-shaped portion producing step). In this manner, a vehicle body fastened portion 22 is formed at a location spaced from the tubular portion 200A by a predetermined distance (corresponding to a dimension of the intermediate portion 24 in the forward-rearward direction Y), as shown in FIG. 5.

Furthermore, the tubular portion 200A is cut at an end 23P facing away from the collar-shaped portion 200B to form an opening in the tubular portion 200A at the end facing away from the collar-shaped portion 200B as shown in (A) in FIG. 5, wherein the opening allows one or more electric wires to be inserted therethrough. In this manner, the shell body 21 and the cylindrical portion 23 are formed.

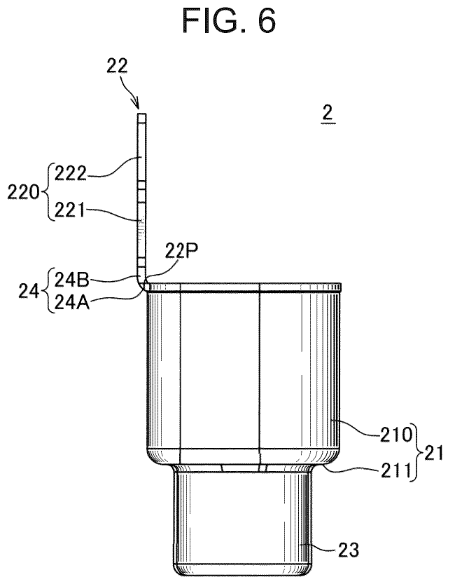

Subsequently, the collar-shaped portion 200B is bent at a location 22P spaced from the tubular portion 200A to form a step 24A, as shown in (B) in FIG. 5 and FIG. 6 (step producing step). Here, a stress which has been applied during the cylindrical deep drawing process may act on the periphery portion of the tubular portion 200A to cause some deformation therein. However, due to the step 24A, the vehicle body fastened portion 22 is formed in a planar region of the collar-shaped portion 200B which allows a dimensioning management. This means that it is possible to form a width dimension L1 of a rectangular portion 221 of the vehicle body fastened portion 22 (dimension between the pair of contact surfaces 22B) which is substantially equal to a dimension of the target portion 10 between the pair of inner surfaces 12A, 12A.

In this manner, the shield shell 2 is completely produced. This shield shell 2 is used in the shield structure 1 according to the present embodiment. The produced shield shell 2 is supported at a predetermined location of an electric wire by inserting, into the shielded space 20, a housing holding the electric wire.

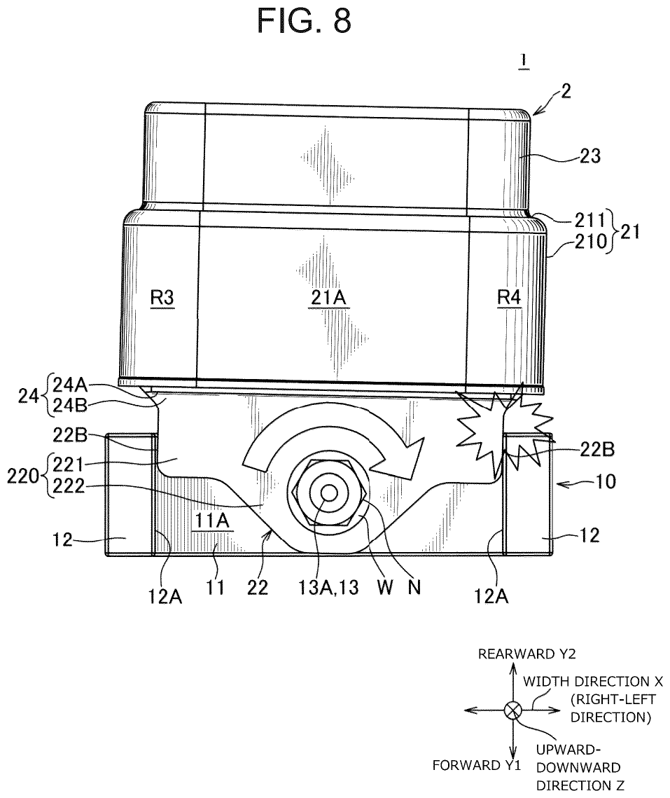

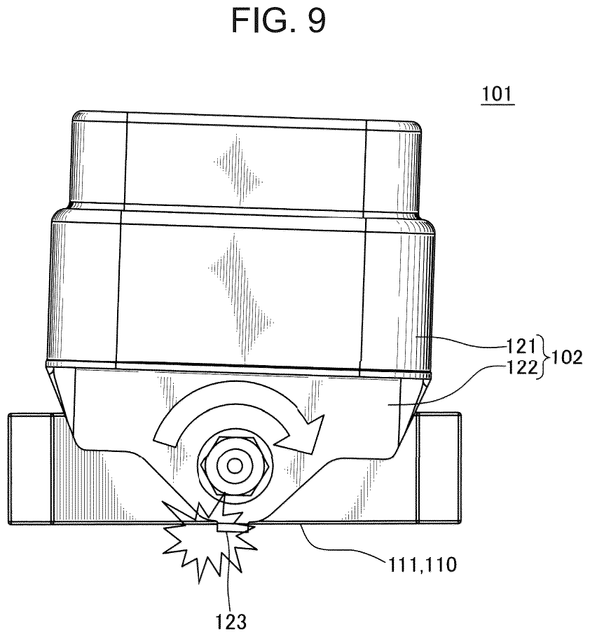

Next, a procedure for fastening the shield shell 2 to the target portion 10 by means of a bolt will be described with reference to FIGS. 7 and 8. The target portion 10 is in a state where the bolt shaft 13A extends upright from the first wall 11, as shown in FIG. 7.

First, the vehicle body fastened portion 22 of the shield shell 2 is moved toward the overlapped surface 11A of the first wall 11 between the pair of second walls 12, 12 of the target portion 10 in a pose facing the overlapped surface 11A as shown in FIG. 7, wherein simultaneously, the bolt hole 22A in the vehicle body fastened portion 22 is moved toward a tip of the bolt shaft 13A extending upright from the overlapped surface 11A. The bolt shaft 13A is then inserted through the bolt hole 22A, wherein the fastened portion body 220 of the vehicle body fastened portion 22 is overlapped with and placed on the overlapped surface 11A of the target portion 10. At this time, each of the pair of contact surfaces 22B, 22B of the vehicle body fastened portion 22 is brought into contact with the inner surfaces 12A of the target portion 10.

Subsequently, a nut N and a washer W are moved toward the tip of the bolt shaft 13A and screwed thereto. By further screwing the nut N, the nut N is brought into contact with the vehicle body fastened portion 22 via the washer W. At this time, a force in a direction of rotation of the nut N acts on the vehicle body fastened portion 22 as shown in FIG. 8. However, the pair of contact surfaces 22B, 22B of the vehicle body fastened portion 22 is in contact with the pair of inner surfaces 12A, 12A of the target portion 10, which establishes a state in which the vehicle body fastened portion 22 is inhibited from being rotated with respect to the target portion 10 and displacement of the vehicle body fastened portion 22 is restricted.

By further screwing the nut N, the vehicle body fastened portion 22 and the first wall 11 of the target portion 10 are clamped between the bolt head 13B and the nut N, whereby the shield shell 2 is fastened to the target portion 10. In this manner, a shield circuit is formed which blocks electric noises leaked to the outside from the electric wire for transferring e.g. control signals, or blocks electric noises introduced from the outside.

According to the above-described embodiment, the pair of contact surfaces 22B, 22B is configured to be in contact with the pair of inner surfaces 12A, 12A in an overlapped state of the fastened portion body 220 of the vehicle body fastened portion 22 which is overlapped with the overlapped surface 11A of the target portion 10. The contact of the pair of contact surfaces 22B, 22B of the vehicle body fastened portion 22 with the pair of inner surfaces 12A, 12A results in a force in the direction of rotation of the nut N acting on the vehicle body fastened portion 22, which accompanies screwing the nut N to the bolt shaft 13A when the shield shell 2 is fastened to the target portion 10 by means of the bolt. However, with the above-mentioned configuration, the contact of the pair of contact surfaces 22B, 22B of the vehicle body fastened portion 22 with the pair of inner surfaces 12A, 12A of the target portion 10 may establish a state of the vehicle body fastened portion 22 in which it is inhibited from being rotated with respect to the target portion 10 and displacement of the vehicle body fastened portion 22 is restricted. This means that the shield shell 2 is inhibited from being rotated with respect to the target portion 10 and thus fixed at an appropriate location of the target portion 10. This may enable an accuracy of a fixed location on the target portion 10 of the vehicle body to be improved.

Furthermore, this enables the conventional protruding portion 123 to be omitted, which may reduce material costs.

Furthermore, the pair of inner surfaces 12A, 12A is opposed to each other in the width direction X (orthogonal direction), wherein each of the pair of contact surfaces 22B, 22B is defined by a plane including the axial direction of the shell body 21. With this configuration, the pair of contact surfaces 22B, 22B of the vehicle body fastened portion 22 has a sufficient contact area for contact with the pair of inner surfaces 12A, 12A, which may enable the accuracy of the fixed location on the target portion 10 of the vehicle body to be further improved.

Moreover, the pair of contact surfaces 22B, 22B is arranged within the boundary positions P1 and P2 between the bottom wall 21B and the respective bent portions R1 and R2. Such a vehicle body fastened portion 22 is provided at the shell body 21 with the step 24A interposed therebetween and formed in a planar, plate-shaped region which allows dimensioning management. This enables a dimension L1 of the vehicle body fastened portion 22 in the width direction X (orthogonal direction) to be formed which is substantially equal to the dimension of the target portion 10 between the pair of inner surfaces 12A, 12A. This further facilitates that the pair of contact surfaces 22B, 22B of the vehicle body fastened portion 22 has a sufficient contact area for contact with the pair of inner surfaces 12A, 12A.

The production method of producing such a shield shell 2 includes forming the deep-drawn material 200 in the deep drawing step, subsequently forming the vehicle body fastened portion 22 in the vehicle body fastened portion producing step, and forming the step 24A in the step producing step to form the shield shell 2. Here, the step 24A is formed by bending the collar-shaped portion 200B at the location 22P spaced from the tubular portion 200A (shell body 21), wherein the vehicle body fastened portion 22 is provided with the step 24A interposed between the vehicle body fastened portion 22 and the shell body 21. In this manner, the vehicle body fastened portion 22 is formed in a planar, plate-shaped region of the collar-shaped portion 200B which allows dimensioning management. This enables a dimension L1 of the vehicle body fastened portion 22 in the width direction (orthogonal direction) to be formed which is substantially equal to the dimension of the target portion 10 between the pair of inner surfaces 12A, 12A, which results in a sufficient contact area of the pair of contact surfaces 22B, 22B of the vehicle body fastened portion 22 for contact with the pair of inner surfaces 12A, 12A, whereby the shield shell 2 is inhibited from being rotated with respect to the target portion 10 and thus fixed at an appropriate location. This may enable the accuracy of the fixed location on the target portion 10 of the vehicle body to be further improved.

Although the best configuration, method etc. for implementing the present invention are disclosed in the above description, the present invention is not limited thereto. Namely, while the present invention is particularly shown and described mainly with regard to the specific embodiments, the above mentioned embodiments may be modified in various manners in shape, material characteristics, amount or other detailed features by those skilled in the art without departing from the scope of the technical idea and purpose of the present invention. Therefore, the description with limited shapes, material characteristics etc. according to the above disclosure is not limiting the present invention, but merely illustrative for easier understanding the present invention so that the description using names of the elements without a part or all of the limitations to their shapes, material characteristics etc. is also included in the present invention.

### REFERENCE SIGNS LIST

1 Shield structure
2 Shield shell
20 Shielded space
21 Shell body
21B Bottom wall (at least one wall)
21A, 21B, 21C, 21D Four walls including the one wall
22 Vehicle body fastened portion
22A Bolt hole
22B, 22B Pair of contact surfaces
22P Location spaced from the tubular portion
220 Fastened portion body
24A Step
10 Target portion of a vehicle body
11A Overlapped surface
12A, 12A Pair of inner surfaces
R1, R2, R3, R4 Bent portions
P1, P2 Ends of the bottom wall (boundary positions between the wall and respective bent portions)
200 Deep-drawn material
200A Tubular portion
200B Collar-shaped portion
13 Bolt
Y Forward-rearward direction (axial direction of the shell body)
X Width direction, right-left direction (orthogonal direction extending orthogonally to the axis)

What is claimed is:

1. A shield structure configured to be fixed to a target portion of a vehicle body, wherein the target portion is intended for mounting the shield structure thereto, the shield structure comprising:
a shield shell including:
a shell body having a tubular shape, the shell body including at least one wall and defining a shielded space; and
a vehicle body fastened portion which has a plate shape and is continuous with the one wall via a step, the vehicle body fastened portion extending in an axial direction of the shell body and being configured to be fastened to the target portion by means of a bolt,
wherein the target portion includes an overlapped surface and a pair of inner surfaces, the overlapped surface being configured to be placed facing the vehicle body fastened portion and overlapped with the vehicle body fastened portion, wherein the pair of inner surfaces extends upright from the overlapped surface and opposed to each other,
wherein the vehicle body fastened portion includes a fastened portion body having a plate shape, a bolt hole and a pair of contact surfaces, the bolt hole being provided in the fastened portion body and configured for inserting the bolt therethrough, wherein the pair of contact surfaces is provided on end faces of the fastened portion body in an orthogonal direction and is able to come into contact with the inner surfaces, wherein the orthogonal direction extends orthogonally to an axis of the shell body, and
wherein the pair of contact surfaces is configured to be in contact with the pair of inner surfaces in an overlapped state of the fastened portion body which is overlapped with the overlapped surface.

2. The shield structure according to claim 1,
wherein the pair of inner surfaces is opposed to each other in the orthogonal direction, and
wherein each of the pair of contact surfaces is defined by a plane, the plane including the axial direction of the shell body.

3. The shield structure according to claim 1,
wherein the shell body includes four walls and bent portions between the four walls, the four walls including the one wall, wherein the bent portions are continuous with the four walls and form corners of the shell body, and
wherein the pair of contact surfaces is arranged within boundary positions between the one wall and respective bent portions.

4. The shield structure according to claim 2,
wherein the shell body includes four walls and bent portions between the four walls, the four walls including the one wall, wherein the bent portions are continuous with the four walls and form corners of the shell body, and
wherein the pair of contact surfaces is arranged within boundary positions between the one wall and respective bent portions.

5. A shield shell production method of producing a shield shell, comprising:
a deep drawing step of forming a deep-drawn material by applying a cylindrical deep drawing process to a metal sheet, the deep-drawn material including a tubular portion; and
a collar-shaped portion producing step of applying a punching process to the deep-drawn material and thus forming a collar-shaped portion which extends continuously in a collar shape along a periphery of the tubular portion; and
a step producing step of forming a step by bending the collar-shaped portion at a location thereof which is spaced from the tubular portion.
